(19) United States
(12) Patent Application Publication
(10) Pub. No.: US 2023/0220627 A1
(43) Pub. Date: Jul. 13, 2023

(54) Water & Oil Impermeable Paper Products, Paper Bags and the Process for Manufacturing the Same

(71) Applicant: Multi-Forms Corporation, Quezon City (PH)

(72) Inventor: Johnson Fong, Quezon City (PH)

(21) Appl. No.: 16/969,922

(22) PCT Filed: Feb. 13, 2018
(86) PCT No.: PCT/PH2018/000007

§ 371 Date: Aug. 13, 2020

(30) Foreign Application Priority Data
Feb. 13, 2018 (PH) 12018000046

(51) Int. Cl. D21H 19/20; D21H 19/28; D21H 23/38; D21H 25/00; D21H 25/04

(52) U.S. Cl. CPC D21H 19/20; D21H 19/28; D21H 23/38; D21H 25/005; D21H 25/04

(57) ABSTRACT

Paper products, which could be made into bags, wrappers, receptacles, cups, boxes, and the like, are disclosed. The paper is coated with a water-resistant and oil resistant coating. In the case of forming paper bags, pouches, and the lie, the adhesives that could be used to bond the coated side in juxtaposition that can form a high bonding power can be any latex-base modifier copolymer, or modified loctite by heat sealing or the use of styrene ester copolymer are also disclosed.

### FIELD OF THE INVENTION

This invention relates to paper, paper bags, paper board, and other paper substrates that is toxic free and biodegradable, suitable for use as food wraps, bags, and food trays and the process for manufacturing such, that provides protection against water and oil/grease. Water and oil/grease repellant coatings are in the form of a very thin film in such a way that both media cannot penetrate into the fibers of the Paper substrate. The production of the said invention is more environmentally friendly since the coatings may preferably made from waste precursors that are biodegradable. In addition, since this invention could be modified in such a way that it could be used as food wrappers, bags, receptacles etc., the relevant adhesives that can be deployed with extra high bonding powers which are water oil/grease repellant under certain weather conditions is described herein.

### BACKGROUND OF THE INVENTION AND DESCRIPTION OF PRIOR ART

Many of the food wrapping papers, kraft paper bags, paper boards in the market today use different forms of wood fibers or additives in the paper making process such as internal sizing, surface sizing, and impregnation of polymers into the fibers to produce different grades of papers/paper bags or paperboards for use by converters whose main purpose is to transform the paper into food wrappers, kraft paper bags, food boxes, food trays, drinking cups, grease proof papers such as glassine paper, and other oil proof paper. In standard industrial papers, its tensile strength is well dependent on the types of fibers used, thickness of the papers, amount of wet strength chemicals added into the fibers, fineness in the processing of the fibers at the wet end of the paper making process. The more polymeric substance that are added into the sizing process, internal or surface sizing, the more the paper becomes non-Biodegradable and more difficult to compost in the dump sites.

However, it is inevitable that when papers or paperboards are use as a packing material for food items, the different internal or surface sizing materials are added in the paper milling process, as the papers will be exposed to different environmental factors most specially moisture and grease, the mill has to incorporate different type of impregnating chemicals to suit the end use. In U.S. Patent No. US 2008/0003384 A1 to Christopher B. Murphy, assigned to Polymer Ventures, Inc., it was revealed that a method used by Murphy to improve the gas, water, water vapor and/or grease resistance was the application of wax, polyvinyl alcohol, and polyamide was disclosed. The method employed by Murphy was to treat the paper by coating of layers of the materials cited in his invention.

Fluorochemical compounds which are effective as grease and water barriers on paper, fabrics, carpet fibers is now banned worldwide due to its environmental impacts. To this, wax become the preferred material as grease/water repellant on paper and paperboard, however, the use of petroleum base wax has its short comings and compostability becomes an issue.

In U.S. Pat. No. 5,635,279 to Ma et al, replicable, water repellent paperboard was described that has a coating compose of wax mixed with polymer, a preferred polymer matrix was described as comprising a polystyrene-butadiene polymer polymerized with a monomer having carboxylic acid pendant groups. In the same patent, polyvinyl alcohol is described as being an ironically cross-linkable polymer that could be used in the invention. In U.S. Pat. No. 5,151,404 to Suzuki et al. describes thermosensitive recording papers that does not curl and provides clear images with high image density, and that the polyvinyl alcohol can be used as stiffness imparting agent.

In EP2438123A1 to Ernst Schoenleitner et al, described a waterborne coating composition comprising a water dispersible polyester resin and a metal salt of a fatty acid, to a substrate having been coated with this composition that has the effect to repel or as a barrier against water. In one of the embodiment, it was cited that polyvinyl alcohol and a fatty acid melamine wax can improve the water repellency. In another embodiment, the use of water dispersible polyester resin can be added in the wet end of the paper making process to produce paper for food wraps that will greatly reduce the adhesion of the bun to the wrapper. Furthermore, it claims that the coated substrate exhibits good grease resistance properties.

In patent U.S. Pat. No. 005,958,601 to Salsman, it was disclosed the synthesis from PET particularly post consumer, recycled plastics of novel water dispersible or emulsifiable polyester resins having improved hydrophobicity the coatings of which has improved water repellency while at the same time retaining their re-dispersible or re-emulsifiable properties. The resins can be used in Paper, textile, paint and other industries. In this patent, the object of invention is to provide water soluble or water dispersible polyester resin compositions having improved oil and water repellency. However, our test results show that the oil repellency is wanting, a kit test show a failure to arrest the oil resistance it desires to attain, but the water repellency is good.

Furthermore U.S. Pat. No. 4,977,191 to Salsman describes the production of a water soluble/dispersible resin from used or waste polyester, glycols, isophthalic acid and oxyalkylated polyols which is most useful in fiber, fabric and/or paper sizing, however, the application of these resins to paper is not expounded in any of the patents described. In addition, these polyester resins are not perfect in giving the paper the ultimate resistance to water or specially as barrier of grease since the resin coating have micropores in which several media could pass.

Since the polyester's orientation is such that the hydrophobic groups are away from the Paper substrate, polar solvents such as water tend to be excellently repelled by the coatings as exhibited by the high contact angles generated. But non-polar solvents like oil may pass through the micropores from the coatings and the micropores of the substrate, specially at high temperature. Hence, the need to improve or create as novel barrier coat to improve water repellency and oil barrier in blocking the micropores on the Paper substrate is the focus of this invention.

U.S. Pat. No. 6,193,831 B1 to Overcash and Elsenbaumer uses various polymers in providing oil/grease and water resistance properties to baking papers in particular. The polymer itself, which exhibits oil resistance properties, may be cross-linked to resist moisture even at high temperature. In U.S. Pat. No. 6,162,836 by Kato Yasuo has use higher fatty acid zinc salt with zinc stearate in reacting with polyvinyl alcohol having a saponification degree of 88 mole that yielded a zinc stearate of 99.3% in making a higher fatty acid for use as lubricant incorporated in a coating solution for the production of coated paper to prevent dusting or flooring or as a viscosity stabilizer for the coating.

As more consumers are shying away from plastic, such as styrofoam which are now ban in many countries, there are tendencies to use other plastic containers such as blow mounding containers made from polypropylene, which visually looks like PET plastic which is free from BPA, however such materials remain as non-Biodegradable, difficult to recycle, which leaves a large carbon footprint that is detrimental for the environment. In US patent 20040005341 A1 described a Paper and paperboard coated with Polyethylene resin with polyvinyl alcohol as one of the elements in mixture with fatty acid melamine wax as the main function to grease resistance.

Cellulosic substrates, such as Paper, paperboard, and other substrates as textile are often laminated or coated, such as the 3M Scotchgard products, is a water soluble fluorochemical sizing agent that imparts grease and oil resistance to paper, paperboard, and pigmented coatings. However, 3M and many other manufacturer have ceased to produce the grease/oil resistant materials made from fluorochemicals due to its impact to the environment.

In U.S. Pat. No. 8,802,205 B2, Pete Bugas et al, disclosed a repulpable and recyclable moisture resistant poultry box made from corrugated board with hydrogenated triglyride and hydrophobic Polyethylene terephthalate. This differentiated from the conventional use of paraffin wax and synthetic polymers which are difficult and often impossible to recover and repulp due to the fact that the petroleum waxes and polymers are non-Biodegradable that causes harm on the environment.

This invention relates to a composition of a water and grease resistant barrier coating for cellulosic substrates which is food-safe, compostable, and recyclable. The composition of such barrier coating includes polyvinyl alcohol, metal salt of fatty acid, cross-linking agent, and water dispersible hydrophobic polyester resin. The water and grease resistance properties are retained even at temperatures as high as 160 degree Celsius for a duration of 30 minutes. When freeze to negative 40 degree Celsius for 30 minutes, it does not show any signs of polymer fatigue that may be visible thru crack lines, and may also stand a 204 degree Celsius for 15 minutes in an convection oven.

Polyvinyl alcohol (PVA) is known for its oil, grease and solvent barrier, yet in its original form is water soluble. Therefore by modifying the PVA, such as adding hydrocarbon groups to its parent polymer chain, can improve not only its oil, grease and solvent resistance, but also impart other properties such as gas barrier and water resistance. U.S. Pat. No. 7,939,138 B2 disclosed the uses of polyvinyl alcohol and cross-linked with other chloroformate Ester's such as ureas, urea formaldehyde polymer, melamine formaldehyde polymers, borates, phosphonates. This is applied at the Fourdrinier end of the Paper machine, just before the web of paper goes into the dryers for drying.

### DETAILED DESCRIPTION OF THE INVENTION AND PREFERRED EMBODIMENTS

This invention describes the composition of a water and grease resistant barrier coating for cellulosic substrates. The said cellulosic substrates, coated with the barrier coating of this invention, is food-safe, compostable and recyclable. The water and grease resistance properties are retained even at high temperature of 204 degree Celsius, for an average duration of 15 minutes or at a temperature of 160 degrees Celsius for an extended time of 30 minutes in an convection oven without breaking down the coatings on the surface of the substrates.

The composition of the said water and grease resistant barrier coating comprises of polyvinyl alcohol, metal salt of fatty acids, a cross-linking agent, and water dispersible hydrophobic polyester resin. The said polyvinyl alcohol in one embodiment of the invention is about 12% to 55% composition by dry weight of the coating barrier, with more preference to 18% to 45% by dry weight composition, and much more preference to 20% to 35% by dry weight composition. The said metal salt of fatty acid in one embodiment of the invention is about 12% to 18% composition by dry weight of the coating barrier, with more preference to 3% to 15% by dry weight, and much more preference to 4% to 12% by dry weight composition. The said cross-linking agent in one embodiment of the invention is about 0.5% to 8% composition by dry weight of the coating barrier, with more preference to 1% to 7% by dry weight composition, and much more preference to 2% to 6% by dry weight composition. The said water-dispersible hydrophobic polyester resin in one embodiment of the invention is about 25% to 80% composition by dry weight of the coating barrier, with more preference to 35% to 75% by dry weight composition, and much more preference to 20% to 45% by dry weight composition.

The described polyvinyl alcohol of this invention may be of different degrees of hydrolysis, saponification, and polymerization. It may be of intermediary, partially, fully or super hydrolized. It may also include modified polyvinyl alcohol polymers, such as those added with hydrocarbon groups or any reactive agents that would improve its water, oil, grease and solvent resistance. Examples of such modified polyvinyl alcohols are those added with carbonyl groups, sulfonic groups, vinyl groups, acetacetyl groups, ethylene oxide groups, and ammonium salt groups.

The described metal salt of fatty acid includes any metal cation which is compatible for food contact reacted to a fatty acid to form a salt. Said metal cations include ferrous, ferric, zinc, magnesium cations. The fatty acid described in one embodiment of the invention are 6 to 24 carbons long, which may be of straight chain or branched, and may be saturated or unsaturated. Examples of such fatty acids are lauric acid, tridecyclic acid, myristic acid, palmitic acid, margarita acid, stearic acid, arachidic acid, and heneicosylic acid. The metal salt of fatty acid is the combination of the described metal cation and fatty acid above which is nontoxic and safe with food contact.

The cross-linking agent described in one embodiment of the invention may be any cross-linking compound which is nontoxic and safe with food contact. It may also be a modified version of the cross-linking agent with its toxicity removed and made safe with food contact. The described cross-linking agent will improve the barrier properties of polyvinyl alcohol by cross-linking the polymer chains. Examples of the cross-linking agent includes, but not limited to, sodium borate decahydrate, glutaraldehyde, sodium glyoxal, malondialdehyde, succindialdehyde, and phthalaldehyde.

The described water-dispersible hydrophobic polyester resin can be any hydrophobic polyester that is safe with food contact, compostable, and recyclable. It can also be modified to impart compostable and recyclable properties. Examples of hydrophobic polyester include, but not limited to, are polylactic acid, polyisocyanurate, Polyethylene therepthalate, polybutylene Terephthalate, Polyethylene napthalate, and polyhydroxybutyrate.

The coating barrier is applied onto paper as a coating solutions. A barrier coating solution may contain one, two, or three of the components described in this invention, which are polyvinyl alcohol, metal salt of fatty acid, cross-linking agent, and water dispersible hydrophobic polyester resin. In one embodiment, the barrier coating is applied as three separate solutions with two of the mentioned components present in one solution and the other components in separate solutions. In another embodiment, the barrier coating is applied as two separate solutions, with each solution containing only two of the mentioned components. In another embodiment, the barrier coating is applied as two separate solutions, with one solution containing three of the mentioned components while the other contains only one of the components. The viscosity of such coating solutions is not beyond 500 cps, with more preference of viscosity about 200 cps to 350 cps, and greater preference of viscosity of less than 300 cps. The total solids content of the coating solutions is about 40% by weight, with more preference to less than 25% by weight, and greater preference of less than 20% by weight.

Having two or more coating solutions, the coating barrier may have two or more layers. In one embodiment, the barrier coatings has three layers, with two layers containing only one of the mentioned components and one layer containing two components. In another embodiment, the barrier coating has two layers, with each layer containing two different components mentioned. In another embodiment, the barrier coating has two layers. With one layer containing only one component and the other three components.

Additives such as binders, mineral fillers, mineral clays, preservatives, sizing agents and optical brighteners may be added onto one or more of the coating solutions to further improve the desired characteristics of the paper and/or the barrier coatings without decreasing its water and grease resistance.

The desired water and grease resistance of the cellulosic substrate coated with this invention can withstand temperature to as high as 160 degree Celsius for 30 minutes and to a temperature to as high as 204 degree Celsius for a duration of 15 minutes when the substrate use is a 300 gsm paperboard. The same type of substrate can be placed in a freezing temperature of below −40 Celsius and no sign of cracks or deformation is visible, the water and grease resistance characteristic was observed are still in place.

### EXAMPLES

### Preparation of Polyvinyl Alcohol (PVA) Solution 1 and Other Solutions

The polyvinyl alcohol in general may be any grade from medium polymerization and the degree of hydrolysis my be partial, or fully hydrolyzed. With agitation, dissolve about 0.5˜0.7 parts (by mass) PVA onto 9.5˜9.3 parts of water in an appropriate beaker, slowly heat the solution to 90 degree Celsius while maintaining 90 degree Celsius, add about 0.5 part of dialdehyde with agitation and maintain the temperature for 5 to 10 minutes. Remove from heat and let the solution cool to room temperature.

1 part of PVA solution solution 1, 1 part of zinc stearate emulsion, add-mix the solutions together and agitate at high speed for 5-10 minutes. The mixture of the solutions were applied onto a sheet of 30 gsm & 40 gsm papers. The hand coated paper was then dried in a convection oven at 80*C for 5 to 10 minutes. Then subsequently hand coat this paper with water dispersible polyester solution on juxtaposition to the first layer of hand coated solutions and dried in the same manner inside a convection oven.

The coat weight of the barrier coatings was 7 gsm, at this time, the paper was left to stand in ambient temperature. Then oil resistance test was conducted with kit 8 solutions, then simultaneously water droplets were poured onto the surface of the paper to observe its surface tension and absorbency of the polar liquid. The paper passed the kit 8 test after contact with oil test liquid in accordance with the TAPPI standard oil resistance test. It was observed that at ambient temperature after 5 minutes no oil spot was observed and the paper resisted water for 30 minutes before any noticeable softening of the paper was observed.

The same paper was subjected to a heat test to observe oil resistance level. In a convection oven heated to 100*C, the paper was placed inside the oven for a 3 minutes heat test, there was no oil spots seen within this period and no water damage was noticeable after 5 minutes.

### Preparation of PVA Solution 2 & Coating Solution 2

The PVA use in this invention may be partially hydrolyzed to fully hydrolyzed and medium to high molecular weight. With agitation, dissolve about 1˜3 parts PVA onto 9˜7 parts of water in an appropriate beaker with water. Slowly heat the solution to 90 degree Celsius, then remove from heat and let solution cool to room temperature.

In the preparation of the coating solution, mix 11 parts of PVA solution, 1 part of zinc stearate emulsion, into 1.4 parts of water then mix-agitate with high speed mixer for 5˜10 minutes.

### Example 2

In the hand coating process, similar procedures of hand held metering rod was use to lay down the emulsion onto a 30 gsm base paper as used in example 1, with the above coating solution laid down on the base paper as the first step, a layer of water dispersible polyester was added. The coat weight under this example was established at 5.8 gsm (grams/square meter). To test the hand coated paper against oil and water resistance, oil test kit No. 6 was used, the test results within 3 seconds as prescribed by TAPPI test standards, the coating passed the kit 6 level, then a kit 8 was used, which also shown the high resistance to oil. In an ambient condition, the oil droplet was left on the surface of the paper for 30 minutes there was no noticeable oil spots at the back of the paper. In the water resistance test, water was drop onto the coated surface of the paper and left in ambient temperature for 30 minutes, there was no moisture at the back of the paper, however, after more than a 30 minutes lapse time had been observed, the back of the paper was noticeably softening. When the same paper was placed inside a convection oven with temperature of 100*C, no oil spots were seen after 5 minutes, and no further water damaged was seen after more than 7 minutes.

A simultaneous test was also conduct on a 30 gsm paper with only water dispersible polyester resin was hand coated onto the surface of the paper, with a coat weight of 5 gsm, but without oil resistance and pva compounds were coated as a base. There was no noticeable water penetration was seen even after a long period of 20 minutes, but softening of the paper was observed. When oil resistance test was conducted with kit 3 oil test formula, there was an obvious oil leak and within 3 seconds, oil spots were visible on the back side of the water soluble polyester coated paper, concluding that by itself, the water soluble polyester resin has very weak oil repellency, but strong water repellency.

### Preparation of PVA Solution 3, Coating Solution 3, Solution 4

### Example 3

Same preparation as that of PVA solution 1, but using 1.5 parts of PVA, 9 parts water and 0.5 parts of dialdehyde. Homomix 10.5 parts of PVA solution 2, 1 part of zinc stearate emulsion, and 1.3 parts of water, agitate it for 5˜10 minutes, then add 1.1 parts of dialdehyde into the solution then agitate by stirring.

### Example 4

Coating solution no. 4 was also prepared by using 10.5 parts of PVA solution 3, with 1 part of zinc stearate solution, 1.3 parts water. And 1.1 parts of dialdehyde. The three coating solutions were applied one at a time onto a 30 gsm paper. The coating solution No. 3 was first applied to dry, with coating solution No. 4 but was diluted by 4%˜6% in water. Then the last layer was the water soluble polyester resin as the top most layer. The paper was dried in a convection oven at 80*C for 20 minutes.

The coat weight of the coatings was at 7.8 gsm. Same test was done for oil and water resistance was made on the paper, at ambient condition, such as 24*C in an air conditioned room, no oil spots were seen for more than 10 minutes and resisted water for more than 30 minutes. Oil test was a kit 10 solution as per TAPPI standard test method.

In another test example, 2 coating solutions were applied onto a 30 gsm paper, similar to example 1, but this time only coating solution 4 and water dispersible polyester resin were used. The coat weight of the combined layers was 6.2 gsm, a much lighter coat weight was observed. The paper was subjected to the same oil resistance test as well as the water resistance test. When the paper was subjected to oil test at Kit 9 there was no visible oil spots after the standard time lapsed of 15 seconds, the kit test oil was left on the surface of the paper for another 30 minutes, there was no visible oil spots. When water was dropped onto the surface of the paper, there was no visible water moisture at the back side of the paper after a 30 minutes time lapsed. When the paper was placed inside a convection oven at 100*C for 5 minutes to test the oil resistance, there was also no visible oil spots despite the heated temperature inside the oven. In like mariner, there was no water moisture at the other side of the paper after a 30 minutes exposure inside the oven at 100*C.

### Preparation of Coating Solution 5, Coating Solution 6

For coating solution No. 5, the same method as coating solution 3, but using 9 parts of PVA solution 2, 1 parts of zinc stearate solution, and 1.1 part of dildehyde. Coating solution No. 6 was prepared in the same method as coating solution No. 5, but using 9 parts of PVA solution 3 instead of PVA solution 2.

Example 5, the 2 coating solutions were applied onto a sheet of 30 gsm paper, in same manner as example 1, but coating solution 6 was first applied before the water dispersible polyester resin was applied.

The coat weight of the hand coating of the barrier coating was 6.4 gsm. Similar oil and water test method was employed as previously conducted. At ambient temperature, oil test kit solution No. 8 was deployed. After the initial oil test was done, a time lapse of 15 seconds was observed, and a further prolong oil contact was observed for 30 minutes, likewise water repellency was also tested for a duration of 30 minutes, there was no traces of oil spots and water moist was noticeable after the prolong 30 minutes test.

In a heated convection oven, the paper was placed inside the over with a temperature of 100*C for 3 minutes, there was no traces of oil leaks or water softening of the paper. Then the paper was placed inside the oven for another 10 minutes to observe oil spots due to the expansion of the paper surface, still no oil spot was seen.

### Example No. 6

The 2 coating solutions were applied onto a sheet of 60 gsm kraft paper, similar as example No 1, but coating solution No. 5 was first applied onto the paper before applying with the polyester resin as water barrier coat.

The coat weight of the 2 barrier coats was 6.8 gsm, then the similar oil and water resistance test was conducted. At ambient temperature no oil spots was seen after more than 45 minutes had lapsed, and water resistance was tested and prolong for 45 minutes. To further test the oil resistance test, the paper was placed inside a convection oven heated to 100 degree celsius for 5 minutes no oil spots and no noticeable water damage for more than 10 mins were seen after the heated test.

### Preparation of Coating Solution 7

Same method as coating solution 3, but using 9.2 parts of PVA solution 2, 1.2 parts zinc stearate emulsion, 1.6 parts calcined kaolin solution and 1.6 parts of dialdehyde.

### Preparation of Coating Solution 8

Same method as coating solution 7, but using PVA solution 3 instead of PVA solution 2

### Example 7

Two coating solutions were applied on a 60 gsm kraft paper use for paper bags, similar in example 1, but coating solution 7 was first applied before applying with a water-dispersible polyester resin.

The coat weight of the barrier coat was 6.3 gsm, similar tests for oil and water resistance were done. At ambient temperature, no oil spots were seen for more than 30 minutes and resisted water for more than 30 minutes. In a convection oven at 100 degree Celsius, no oil spots were seen for more than 5 minutes use kit 6 oil test, and no noticeable water damage was observe for more than 10 minutes.

The coated kraft paper under this test was made into a paper bag, then a roasted chicken was placed inside the bag. The convection over was set to 160 degree Celsius, then the cold chicken was placed inside the bag and was left in the oven for 30 minutes to reheat the chicken. After the 30 minutes heating, the bag with the roasted chicken inside was taken out to check oil leaks, and also to check the polyester resin condition after the prolong time of continuous exposure to 160 degree for 30 minutes.

Oil was seen on the bottom side of the bag where it was in direct contact with the metal plate of the convection oven, this simulation was more akin to the paper bag being placed on the surface of a frying pan. Other the top side of the paper bag has very limited minute oil spots. Interestingly, the polyester layer was not deformed or damaged by the constant heat at 160 degree Celsius for a pro long period of 30 m inures.

### Example 8

Two coating solutions were applied onto a 180 gsm paperboard similar in example 1, but coating solution 8 was first applied before applying with a water dispersible polyester resin. Then the paperboard was pasted onto a 370 gsm heat-form pan like tray. The pan was placed inside a freezer with negative 41 degree for 20 minutes. After the pan was taken out of the freezer, there was no visible damage on the 2 layers of coatings. Then pan was placed inside a convection oven at 244 degree Celsius for 15 minutes to observe the heat resistance of the polyester and oil resistance layer. Results show that the brown colored paperboard pan was darker than its original color, but the water resistance was not affected nor the oil resistance coated layer.

The coat weight on the pan-like tray was coated with barrier coat of 10.1 gsm. Similar oil and water resistant test were done. At ambient temperature, no oil spots were visible for a duration of more than 10 minutes and resisted water for more than 10 minutes.

1. A barrier coating composition for cellulosic substrate that imparts water and grease resistance to such substrate, comprising of fully hydrolyzed polyvinyl alcohols, fatty acid metal salt, cross-linking agents, and water-dispersible hydrophobic polyester resins, that is food-safe, compostable, and recyclable.

2. The barrier coating composition according to claim 1, wherein the water and grease resistance is retained at 160 degrees Celsius and above.

3. The barrier coating composition according to claim 1, wherein the cellulosic substrates includes, but is not limited to, food grade paper and kraft paper for making paper receptacles and other paperboards.

4. The barrier coating composition according to claim 1, wherein the polyvinyl alcohol includes, but is not limited to, partially hydrolyzed PVA, fully hydrolyzed PVA, and modified PVA.

5. The barrier coating composition according to claim 1, wherein the polyvinyl alcohol is about 12% to about 55% composition by dry weight of the barrier coating.

6. The barrier coating composition according to claim 1, wherein the polyvinyl alcohol is of different degrees of hydrolysis and polymerization, with or without organic compound groups such as vinyl, sulfonic, acetoacetylated, and carbonyl groups in their polymer chain.

7. The barrier coating composition according to claim 1, wherein the fatty acid metal salt is about 2% to about 18% composition by dry weight of the barrier coating.

8. The barrier coating composition according to claim 1, wherein the fatty acid metal salt is a readily available emulsion composed of any metal cation and includes, but is not limited to, magnesium, zinc, calcium, sodium, and potassium.

9. The barrier coating composition according to claim 1, wherein the fatty acid metal salt is any fatty acid of 6 to 24 carbon chains long, which may be straight-chain or branched, and which may be saturated or unsaturated.

10. The barrier coating composition according to claim 1, wherein the cross-linking agent is about 0.5% to about 8% composition dry weight of the barrier coating.

11. The barrier coating composition according to claim 1, wherein the cross-linking agent is a cross-linking agent, and includes, but is not limited to, sodium borate decahydrate, glutaraldehyde, sodium glyoxal, malondialdehyde, succindialdehyde, and phthalaldehyde.

12. The barrier coating composition according to claim 1, wherein the water dispersible hydrophobic polyester resin is about 30% to about 80% composition by dry weight of the barrier coating.

13. The barrier coating composition according to claim 1, wherein the water-dispersible hydrophobic polyester resin includes, but is not limited to, polybutylene, polyethylene terephthalate, polybutylene terephthalate, and a mixture of these.

14. The barrier coating composition according to claim 1, with or without additives such as binders, mineral clays, preservatives, and sizing agents.

15. A cellulosic substrate coated with the barrier coating composition according to claim 1, that is water and grease resistant, and is capable of thermo-forming into paper receptacles for food, drink, baking and cooking.

16. The barrier coating composition according to claim 1 of the present invention is coated or applied at the size-press of a conventional Fourdrinier paper machine, or by surface coaters such as air knife, metering rod, blades, roller kiss-type contact with accurate coating weight control to the desired lay down with gas fired air-float dryers and infra-red dryers.

17. The barrier coating composition according to claim 1 of the present invention is applied on the cellulosic substrate of various basis weights to make paper receptacles for wet or frozen produce, paper food receptacles and cups through thermo-forming of different shapes and sizes with water and oil resistance.

18. The water and oil resistant cellulosic substrate according to claim 17, is in square bottom or V-shape bottom seal with double pinch folding with double glue lines at each fold wherein the bottom seal is by water-base lactate, modified copolymer low temperature heat seal glue or styrene-acrylic ester copolymer glue.

19. The barrier coating composition according to claim 1, wherein the barrier coating can be applied to cellulosic substrates for making cups for hot liquids wherein the sides and bottom is sealed by ultra-sound infrared sealing with water-based lactate copolymer, liquid polyethylene, modified copolymer high heat seal glue, or styrene-acrylic copolymer glue.
